(19) United States
(12) Patent Application Publication
(10) Pub. No.: US 2025/0146881 A1
(43) Pub. Date: May 8, 2025

(54) HIGH SPEED OPTICAL FREQUENCY MEASUREMENT DEVICE

(71) Applicant: Lumentum Technology (UK) Limited, Northamptonshire (GB)

(72) Inventors: Luis AMARAL, Northamptonshire (GB); Colin SMITH, Paignton (GB); Giacinto BUSICO, Northamptonshire (GB)

(21) Appl. No.: 18/410,828

(22) Filed: Jan. 11, 2024

Related U.S. Application Data
(60) Provisional application No. 63/595,486, filed on Nov. 2, 2023.

(51) Int. Cl. G01J 9/02

(52) U.S. Cl. CPC G01J 9/0246; G01J 2009/0257; G01J 2009/0261

(57) ABSTRACT

An optical frequency measurement system includes a beam splitter configured to split a light beam into a plurality of measurement beams, including a first measurement beam and a second measurement beam; a first optical frequency measurement subsystem configured to receive the first measurement beam and measure a first frequency of the first measurement beam with a first accuracy range to obtain a first measured frequency that corresponds to a frequency of the light beam; and a second optical frequency measurement subsystem configured to receive the second measurement beam and measure a second frequency of the second measurement beam with a second accuracy range that is narrower than the first accuracy range to obtain a second measured frequency that corresponds to the frequency of the light beam with a higher accuracy than the first measured frequency.

### CROSS-REFERENCE TO RELATED APPLICATION

This patent application claims priority to U.S. Patent Application No. 63/595,486, filed on Nov. 2, 2023, and entitled “HIGH SPEED OPTICAL FREQUENCY MEASUREMENT DEVICE.” The disclosure of the prior application is considered part of and is incorporated by reference into this patent application.

### TECHNICAL FIELD

The present disclosure relates generally to optical wavemeters and to measuring an optical frequency of a light beam.

### BACKGROUND

An optical module may have at least one of an optical transmission function or an optical receive function. In general, in order to implement the optical transmission function and/or the optical receive function, the optical module includes one or a plurality of optical sub-assemblies (OSAs).

An OSA may be configured to convert an electrical signal into an optical signal, or vice versa. For example, an OSA may be used for optical communications in which electrical signals are used to transmit or receive information in a digital format or an analog format. An OSA configured as a transmitter may be configured to convert an electrical signal into an optical signal and transmit the optical signal over an optical fiber connected to the OSA. An OSA configured as a receiver may be configured to receive an optical signal (e.g., the optical signal transmitted by the transmitter OSA) and convert the optical signal back into an electrical signal for signal processing (e.g., demodulation or decoding). An OSA configured as a transceiver that includes both a transmitter and a receiver may be configured to transmit and receive optical signals. An optical fiber may be connected to an OSA by a fiber optic connector.

An optical wavemeter is a common measurement instrument used for testing and calibrating a transmitter OSA. The optical wavemeter may use large optical gratings and, in some cases, reference laser sources in order to measure an optical frequency (or wavelength) of an optical signal, such as a laser beam.

### SUMMARY

In some implementations, an optical frequency measurement system includes a beam splitter configured to split a light beam into a plurality of measurement beams, including a first measurement beam and a second measurement beam; a first optical frequency measurement subsystem configured to receive the first measurement beam and measure a first frequency of the first measurement beam with a first accuracy range to obtain a first measured frequency that corresponds to a frequency of the light beam; and a second optical frequency measurement subsystem configured to receive the second measurement beam and measure a second frequency of the second measurement beam with a second accuracy range that is narrower than the first accuracy range to obtain a second measured frequency that corresponds to the frequency of the light beam with a higher accuracy than the first measured frequency, wherein the first optical frequency measurement subsystem comprises a first optical system having a first frequency response that is unique across a first frequency-span region such that each different frequency value within the first frequency-span region corresponds to a unique measurement value of the first measured frequency, the first frequency being within the first frequency-span region, wherein the second optical frequency measurement subsystem comprises a second optical system having a second frequency response that is unique across a second frequency-span region such that each different frequency value within the second frequency-span region corresponds to a unique measurement value of the second measured frequency, the second frequency being within the second frequency-span region, wherein the second frequency-span region is narrower than the first frequency-span region, wherein the second frequency-span region is centered on the first measured frequency, and wherein the first accuracy range is narrower than half of a frequency range of the second frequency-span region.

In some implementations, a method includes splitting, by a beam splitter, a light beam into a plurality of measurement beams, including a first measurement beam and a second measurement beam; measuring, by a first optical frequency measurement subsystem, a first frequency of the first measurement beam with a first accuracy range to obtain a first measured frequency that corresponds to a frequency of the light beam; and measuring, by a second optical frequency measurement subsystem, a second frequency of the second measurement beam with a second accuracy range to obtain a second measured frequency that corresponds to the frequency of the light beam with a higher accuracy than the first measured frequency, wherein the first optical frequency measurement subsystem comprises a first optical system having a first frequency response that is unique across a first frequency-span region such that the first measured frequency is unique to the first frequency provided at an input of the first optical system a first frequency response that is unique across a first frequency-span region such that each different frequency value within the first frequency-span region corresponds to a unique measurement value of the first measured frequency, the first frequency being within the first frequency-span region, wherein the second optical frequency measurement subsystem comprises a second optical system having a second frequency response that is unique across a second frequency-span region such that the second measured frequency is unique to the second frequency provided at an input of the second optical system a second frequency response that is unique across a second frequency-span region such that each different frequency value within the second frequency-span region corresponds to a unique measurement value of the second measured frequency, the second frequency being within the second frequency-span region, wherein the second frequency-span region is narrower than the first frequency-span region, wherein the second frequency-span region is centered on the first measured frequency, and wherein the first accuracy range is narrower than half of a frequency range of the second frequency-span region.

### BRIEF DESCRIPTION OF THE DRAWINGS

FIG. 1 shows an optical frequency measurement system according to one or more implementations.

FIG. 2 illustrates an example calibration table according to one or more implementations.

FIG. 3A shows a plot of a unique frequency response of the first optical system of an optical frequency measurement system.

FIGS. 3B and 3C show plots of a frequency response of the second optical system of an optical frequency measurement system.

### DETAILED DESCRIPTION

The following detailed description of example implementations refers to the accompanying drawings. The same reference numbers in different drawings may identify the same or similar elements.

Optical wavemeters that use large optical gratings and, in some cases, reference laser sources, are relatively slow. For example, each measurement of an optical frequency may take more than 100 milliseconds (ms). Hundreds to thousands of measurements may be performed for testing a transmission of a transmitter OSA for calibrating the transmitter OSA.

An optical frequency measurement system is provided that can acquire faster measurements (e.g., less than 100 ms) within acceptable accuracy margins (e.g., with little to no loss of accuracy). In some implementations, the optical frequency measurement system may perform 1000 measurements or more per second (e.g., at a minimum measurement rate or frequency of 1 kHz). The optical frequency measurement system may include calibrated optics to achieve faster measurement capabilities. For example, the optical frequency measurement system may include a plurality of optical filter blocks, including an initial optical filter block and one or more subsequent optical filter blocks (e.g., one or more subsequent periodic optical filter blocks). A periodic optical filter block may be or may include one or more interferometers, such as one or more etalons, one or more dual-slope etalons, one or more Michelson interferometers, one or more Mach-Zehnder interferometers, or one or more delay line interferometers (DLIs). The one or more subsequent optical filter blocks may be calibrated based on one or more measurements acquired using the initial optical filter block. With sufficient calibration of the one or more subsequent optical filter blocks, the plurality of optical filter blocks may be used to measure a frequency of an optical signal both with high accuracy (e.g., less than 0.1 GHZ, or within a 0.1 GHz margin of error) and high measurement acquisition speed (e.g., 1 kHz or higher). With optimized electronics and photodiodes, the measurement acquisition speed of the optical frequency measurement system may be 10 kHz or higher, 1 MHz or higher, or 1 GHz or higher.

Additionally, or alternatively, the optical frequency measurement system may include a combination of optical components that may require management of component interfaces. For example, polarization management with respect to an assembly of the optical components may be provided to achieve accurate measurements. For example, the optical frequency measurement system may include a polarization scrambler that is configured to average a set of polarization responses to achieve an accurate measurement.

In some implementations, the plurality of optical filter blocks may include decreasing frequency-span regions where each optical filter block has a frequency response (e.g., a periodic frequency response) that is unique and at a same time has increasingly higher frequency discrimination. The plurality of optical filter blocks may be arranged in parallel, but may be used according to a measurement sequence (e.g., sequentially, in series) for a measurement operation. Each optical filter block may have a frequency-span region that has a unique frequency response. In some implementations, the frequency-span region of an optical filter block may be equivalent to a free spectral range (FSR) of the optical filter block. Each subsequent optical filter block may have a smaller or more narrow frequency-span region (e.g., a smaller or more narrow FSR) relative to a previous optical filter block in the measurement sequence. Moreover, each subsequent optical filter block may have a more accurate frequency discrimination characteristic relative to a previous optical filter block in the measurement sequence.

An optical frequency response function may be referred to as a resonant frequency response, a periodic frequency response, or, simply, a frequency response. A transmittivity (and a reflectivity) of an optical filter may depend on a property value of the beam property (e.g., optical frequency, polarization, or spatial property) of a received light beam relative to the optical frequency response function. In other words, the transmittivity (and the reflectivity) of the optical filter varies as a function of the property value. For example, the transmittivity (and the reflectivity) of the optical filter may vary as a function of optical frequency. An intensity of light transmitted through or output by the optical filter may correspond to the transmittivity of the optical filter. Thus, an intensity of each light beam output from the optical filter may depend on the optical frequency of that light beam. In some implementations, two or more optical filters may be used in combination (e.g., in parallel and/or in series) to define a unique frequency response for a particular frequency-span region of an optical filter block. Additionally, or alternatively, an optical filter may provide two or more outputs, each of which may be provided according to a respective frequency response. A combination of the two or more outputs may provide a unique frequency response in a particular frequency-span region.

The plurality of optical filter blocks may each have a unique frequency response in a specific frequency range. Additionally, each optical filter block may provide sufficient accuracy to determine a capture range of a next optical filter block in the measurement sequence. For example, one optical filter block may have a range (e.g., a frequency-span region) of 200 GHz in which the frequency response is unique. A next optical filter block in the measurement sequence may have a range of 20 GHz in which the frequency response is unique. Thus, the frequency-span regions of the plurality of optical filter blocks may sequentially decrease in size.

The subsequent optical filter blocks may not be just one frequency locker (e.g., a single etalon and reference photodiodes) or several frequency lockers that are aligned (e.g., with aligned peaks or nulls in frequency responses) anywhere in a band of interest (e.g., conventional band (C-band) and/or long band (L-band)). If a single etalon or more than one aligned etalon is used, there will be regions with zero frequency discrimination and an accuracy in a region of the zero-frequency discrimination will be poor. Thus, a periodic optical filter block may be an interferometer with two frequency responses, such as a multi-slope etalon (e.g., a stepped etalon) or a DLI, such as a Mach-Zender interferometer, in quadrature The two frequency responses may be shifted by x degrees, not including 0 and 180 degrees. Two or more etalons, DLI channels, and/or other optical filter blocks may be combined, and as many channels as desired for a given optical filter block may be used. Thus, any optical filter block or optical filter block combination used to form an optical filter block may be used as long as a combined frequency response of all of the channels of the optical filter block is unique in a desired frequency-span region, and as long as a previous optical filter block in the measurement sequence has the required frequency discrimination to place a next measurement in the desired frequency-span region (e.g., rather than a next or a previous X GHz region where the next optical filter block does not have a unique frequency response).

The optical filter blocks may not repeat in a next period but rather simply need to have a unique frequency response in any desired frequency-span region (and the previous filter block must have enough frequency discrimination to place the next measurement in a single correct frequency-span region). Additionally, a first, initial filter block may have a unique response in an entire region of interest (e.g., in the C and L bands (C+L bands)). Each filter block may include a linear filter, a wavelength-division multiplexer (WDM) coupler, an interferometer, and/or a DLI, as long as the frequency response of an optical filter block is unique within the entire region of interest.

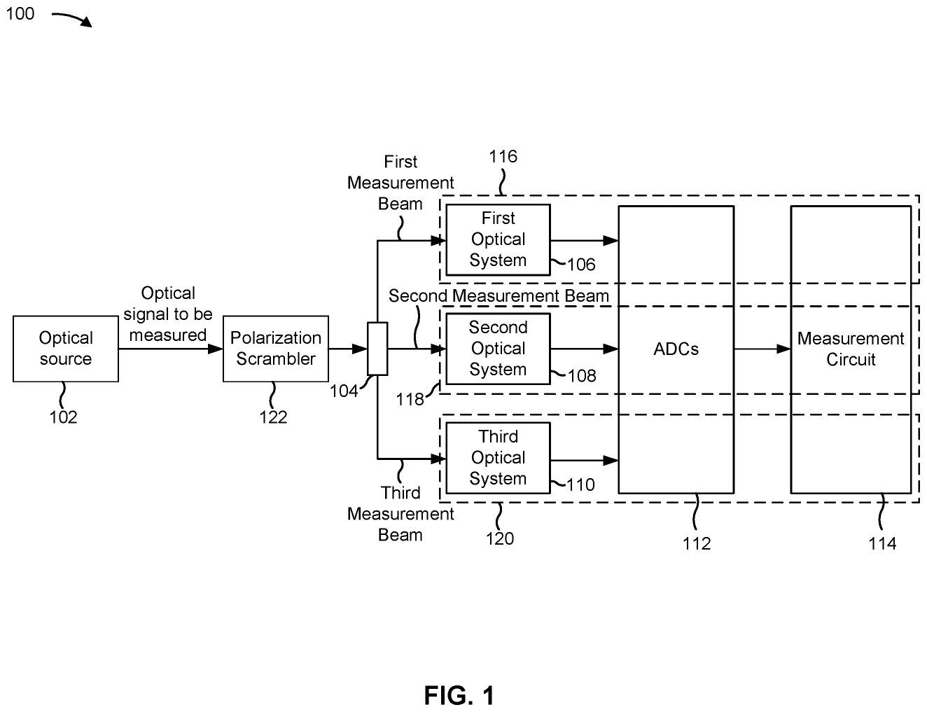

FIG. 1 shows an optical frequency measurement system 100 according to one or more implementations. The optical frequency measurement system 100 may be an optical wavemeter. The optical frequency measurement system 100 includes an optical source 102 (e.g., a light source, such as a laser diode) that produces optical signals (e.g., collimated light beams). In particular, the optical source 102 may generate a light beam for frequency measurement. In some implementations, the optical frequency measurement system 100 may perform wavelength measurements. Since a wavelength is an inverse property of a frequency, frequency and wavelength may be used interchangeably herein. In some implementations, the optical source 102 may be provided externally to the optical frequency measurement system 100. Thus, the optical frequency measurement system 100 may be optically coupled to the optical source 102 for receiving the light beam from the optical source 102.

Additionally, the optical frequency measurement system 100 may include a beam splitter 104 configured to split the light beam into a plurality of measurement beams, including a first measurement beam and a second measurement beam. In some implementations, the plurality of measurement beams may include a third measurement beam. In some implementations, the plurality of measurement beams may include an Nth measurement beam, wherein N is an integer greater than three. In some implementations, the beam splitter 104 may be a power splitter. In some implementations, the beam splitter 104 may provide the plurality of measurement beams as parallel measurement beams.

Additionally, the optical frequency measurement system 100 may include a plurality of optical systems, including a first optical system 106, a second optical system 108, and a third optical system 110. In some implementations, the plurality of optical systems may include an Nth optical system configured to receive the Nth measurement beam. The first optical system 106 may include one or more first optical components (e.g., one or more first optical filters or filter blocks) and one or more photodiodes configured to receive optical signals from the one or more first optical components and generate electrical signals based on the optical signals. The second optical system 108 may include one or more second optical components (e.g., one or more second optical filters or filter blocks) and one or more photodiodes configured to receive optical signals from the one or more second optical components and generate electrical signals based on the optical signals. The third optical system 110 may include one or more third optical components (e.g., one or more third optical filters or filter blocks) and one or more photodiodes configured to receive optical signals from the one or more third optical components and generate electrical signals based on the optical signals. The first optical system 106 may correspond to an initial optical filter block of a frequency measurement operation (e.g., a measurement sequence), the second optical system 108 may correspond to a first subsequent optical filter block of the frequency measurement operation, and the third optical system 110 may correspond to a second subsequent optical filter block of the frequency measurement operation.

Additionally, the optical frequency measurement system 100 may include a plurality of analog-to-digital converters (ADCs) 112 (e.g., high-speed ADCs) configured to receive electrical signals from the photodiodes of the optical systems 106, 108, and 110, and convert the electrical signals into digital signals. One or more ADCs of the plurality of ADCs 112 may be assigned to a respective optical system 106, 108, or 110. For example, one or more ADCs may be coupled to the first optical system 106, one or more ADCs may be coupled to the second optical system 108, and one or more ADCs may be coupled to the third optical system 110 for generating digital signals.

Additionally, the optical frequency measurement system 100 may include a measurement circuit 114 configured to receive and process the digital signals from the plurality of ADCs 112 for performing frequency measurements of the light beam. The measurement circuit 114 may include one or more digital signal processing circuits for processing the digital signals. In some implementations, the measurement circuit 114 may include one or more processors (e.g., one or more digital signal processors (DSPs)) configured to perform computations and/or determine measurement frequencies based on the digital signals. In some implementations, the measurement circuit 114 may include a memory configured to store one or more calibration tables that may be used by the measurement circuit 114 (e.g., by the one or more processors) to determine the measurement frequencies. The calibration tables may be look-up tables used by the measurement circuit 114 to determine the measurement frequencies.

The optical frequency measurement system 100 may include a plurality of optical frequency measurement subsystems, including a first optical frequency measurement subsystem 116, a second optical frequency measurement subsystem 118, and a third optical frequency measurement subsystem 120. For example, the third optical frequency measurement subsystem 120 may be a third optical frequency measurement subsystem. The first optical frequency measurement subsystem 116 may include the first optical system 106, the second optical frequency measurement subsystem 118 may include the second optical system 108, and the third optical frequency measurement subsystem 120 may include the third optical system 110. In addition, each optical frequency measurement subsystem 116, 118, and 120 may include one or more ADCs of the plurality of ADCs 112. Each optical frequency measurement subsystem 116, 118, and 120 may also include processing circuitry of the measurement circuit 114. For example, the first optical frequency measurement subsystem 116, the second optical frequency measurement subsystem 118, and the third optical frequency measurement subsystem 120 may use separate processing circuitry and/or may use shared processing circuitry of the measurement circuit 114 to perform frequency measurements. In some implementations, the first optical frequency measurement subsystem 116, the second optical frequency measurement subsystem 118, and the third optical frequency measurement subsystem 120 may share one or more processors of the measurement circuit 114 to perform frequency measurements.

The first optical frequency measurement subsystem 116 may receive the first measurement beam and measure a first frequency of the first measurement beam with a first accuracy range +/−E1 to obtain a first measured frequency F1 that corresponds to a frequency F of the light beam. The first accuracy range +/−E1 may be an error margin defined by lower error limit −E1 and an upper error limit +E1. Thus, first optical frequency measurement subsystem 116 may measure the frequency F of the light beam to be F1 with an accuracy of +/−E1.

The second optical frequency measurement subsystem 118 may receive the second measurement beam and measure a second frequency of the second measurement beam with a second accuracy range +/−E2 that is narrower than the first accuracy range +/−E1 to obtain a second measured frequency F2 that corresponds to the frequency F of the light beam with a higher accuracy than the first measured frequency F1. The second accuracy range +/−E2 may be an error margin defined by lower error limit-E2 and an upper error limit +E2. Thus, second optical frequency measurement subsystem 118 may measure the frequency F of the light beam to be F2 with an accuracy of +/−E2. The error limits E2 are lower (smaller) values than the error limits E1. Thus, the accuracy of the second measured frequency F2 is better than the accuracy of the first measured frequency F1.

The third optical frequency measurement subsystem 120 may receive the third measurement beam and measure a third frequency of the third measurement beam with a third accuracy range +/−E3 that is narrower than the second accuracy range +/−E2 to obtain a third measured frequency F3 that corresponds to the frequency F of the light beam with a higher accuracy than the second measured frequency F2. The third accuracy range +/−E3 may be an error margin defined by lower error limit-E3 and an upper error limit +E3. Thus, third optical frequency measurement subsystem 120 may measure the frequency F of the light beam to be F3 with an accuracy of +/−E3. The error limits E3 are lower values than the error limits E2. Thus, the accuracy of the third measured frequency F3 is better than the accuracy of the second measured frequency F2.

The first optical system 106 may have a first frequency response that is unique across a first frequency-span region R1 such that each different frequency value within the first frequency-span region R1 corresponds to a unique measurement value of the first measured frequency F1. The first frequency of the first measurement beam may be within the first frequency-span region R1 of the first optical system 106 such that the first optical system 106 can provide a unique frequency response to the first measurement beam.

The second optical system 108 may have a second frequency response that is unique across a second frequency-span region R2 such that each different frequency value within the second frequency-span region R2 corresponds to a unique measurement value of the second measured frequency F2. The second frequency of the second measurement beam may be within the second frequency-span region R2 of the second optical system 108 such that the second optical system 108 can provide a unique frequency response to the second measurement beam.

The third optical system 110 may have a third frequency response that is unique across a third frequency-span region R3 such that each different frequency value within the third frequency-span region R3 corresponds to a unique measurement value of the third measured frequency F3. The third frequency of the third measurement beam is within the third frequency-span region R3 of the third optical system 110 such that the third optical system 110 can provide a unique frequency response to the third measurement beam.

The second frequency-span region R2 may be narrower than the first frequency-span region R1. Moreover, the third frequency-span region R3 may be narrower than the second frequency-span region R2. In addition, the second frequency-span region R2 may be centered on the first measured frequency F1, and the third frequency-span region R3 may be centered on the second measured frequency F2. Additionally, the first accuracy range +/−E1 may be narrower than half of a frequency range of the second frequency-span region R2. In other words, the first accuracy range +/−E1 may be less than R2/2. As a result, the first measured frequency F1, +/−E1, may be within F1+/−R2/2, and the second optical frequency measurement subsystem 118 may have a unique frequency response across F1+/−R2/2. Moreover, the second accuracy range +/−E2 may be narrower than half of a frequency range of the third frequency-span region R3. In other words, the second accuracy range +/−E2 may be less than R3/2. As a result, the second measured frequency F2, +/−E2, may be within F2+/−R3/2, and the third optical frequency measurement subsystem 120 may have a unique frequency response across F2+/−R3/2.

A sum of the first accuracy range +/−E1 and the second accuracy range +/−E2 may be less than half of the frequency range of the second frequency-span region R2. Moreover, a sum of the second accuracy range +/−E3 and the third accuracy range +/−E3 may be less than half of the frequency range of the third frequency-span region R3.

In some implementations, the second frequency-span region R2 may be at least two times smaller than the first frequency-span region R1 (e.g., second frequency-span region R2 may be at least half as wide as the first frequency-span region R1). Moreover, the third frequency-span region R3 may be at least two times smaller than the second frequency-span region R2.

In some implementations, the second accuracy range +/−E2 may be at least one order of magnitude smaller (e.g., at least 10 times smaller) than the second frequency-span region R2, or the second accuracy range +/−E2 may be at least one order of magnitude smaller than the first accuracy range +/−E1. Moreover, the third accuracy range +/−E3 may be at least one order of magnitude smaller than the third frequency-span region R3, or the third accuracy range +/−E3 may be at least one order of magnitude smaller than the second accuracy range +/−E2.

Accordingly, the first optical frequency measurement subsystem 116 has a first measurement resolution, the second optical frequency measurement subsystem 118 has a second measurement resolution that may be higher than the first measurement resolution, and the third optical frequency measurement subsystem 120 has a third measurement resolution that may be higher than the second measurement resolution.

The second frequency response may be unique when the second frequency-span region R2 is centered on any frequency within the first frequency-span region R1. Additionally, the third frequency response may be unique when the third frequency-span region R3 is centered on any frequency within the second frequency-span region R2. Thus, the first accuracy range +/−E1 may be sufficiently small to ensure that the first measured frequency F1 is within the second frequency-span region R2 in which the second frequency response is unique. Moreover, the second accuracy range +/−E2 may be sufficiently small to ensure that the second measured frequency F2 is within the third frequency-span region R3 in which the third frequency response is unique.

The first optical system 106 may include at least one first optical filter that defines the first accuracy range +/−E1 and defines the first frequency response that is unique across the first frequency-span region R1. For example, the first optical system 106 may include at least one monotonic optical filter, at least one wavelength-dependent WDM coupler, at least one periodic filter, or at least one DLI. In some implementations, the first optical system 106 may include a linear-type filter or a filter with an FSR that is less than a full frequency range to be measured such that the first optical system 106 has a unique frequency response across the full frequency range to be measured in order to identify the second frequency-span region R2 of the second optical system 108. In other words, the first frequency-span region R1 extends across the full frequency range to be measured. The first optical system 106 may include a single optical component that provides the first frequency response that is unique across the first frequency-span region R1, or may include a first plurality of optical components that, in combination, provide the first frequency response that is unique across the first frequency-span region R1.

An output power of a monotonic optical filter may depend on frequency and may be sufficiently linear with an input power of the monotonic optical filter. In some implementations, a power ratio of the output power over the input power of a monotonic optical filter may be unique across an entire span of the first frequency-span region R1. Thus, the power ratio may be calibrated to frequency, for example, by using a first calibration table. For example, the measurement circuit 114 may measure the power ratio and cross-reference the power ratio to a frequency in the first calibration table to determine the first measured frequency F1. Thus, using the monotonic optical filter with associated measurement electronics is a possible implementation of the first optical frequency measurement subsystem 116. The associated measurement electronics may sample a photocurrent of the photodiodes to measure the power ratio. Additionally, or alternatively, one or more wavelength-dependent WDM couplers, monotonic filters etalons, DLIs, and/or other interferometers may be used to uniquely define a first frequency response of the first frequency-span region R1, and may be used with associated measurement electronics to measure the first frequency of the first measurement beam to determine the first measured frequency F1.

The second optical system 108 may include at least one second optical filter that defines the second accuracy range and defines the second frequency response that is unique across the second frequency-span region R2. For example, the at least one second optical filter may include at least two periodic filters. In some implementations, the second optical system 108 may include a second plurality of optical components that, in combination, provide the second frequency response that is unique across the second frequency-span region R2. In some implementations, the second optical system 108 may be characterized by a transfer function response that includes the second frequency-span region R2 and has an FSR, where the second frequency-span region R2 is less than the FSR, and the second frequency response is a portion of the transfer function response.

In some implementations, the second optical system 108 may include two etalons having respective frequency responses phase-shifted by approximately one-quarter of an FSR from each other. As a result of the phase shift, a combination of the two etalons may have a unique frequency response across an FSR range, where the second frequency-span region R2 is the FSR in this example. Power measurements may be normalized, for example, by dividing etalon output power or photodetector current over a reference power or a reference photodetector current, respectively. The measurement circuit 114 may measure a first ratio (e.g., output value over reference value, such as output power/reference power) of a first etalon of the two etalons, and measure a second ratio of a second etalon of the two etalons. The first ratio and the second ratio may represent frequency-dependent measurements. The measurement circuit 114 may use both the first ratio and the second ratio in combination to determine a unique frequency measurement of the second measurement beam. For example, a combination of the first ratio and the second ratio may be calibrated to frequency, for example, by using a second calibration table. For example, the measurement circuit 114 may measure the first ratio and the second ratio, and cross-reference the first ratio and the second ratio to a frequency in the second calibration table to determine the second measured frequency F2. Additionally, or alternatively, one or more wavelength-dependent WDM couplers, monotonic filters, etalons, DLIs, and/or other interferometers may be used to uniquely define a second frequency response of the second frequency-span region R2, and may be used with associated measurement electronics to measure the second frequency of the second measurement beam to determine the second measured frequency F2.

The third optical system 110 may include at least one third optical filter that defines the third accuracy range and defines the third frequency response that is unique across the third frequency-span region R3. For example, the at least one third optical filter may include at least two periodic filters. In some implementations, the third optical system 110 may include a third plurality of optical components that, in combination, provide the third frequency response that is unique across the third frequency-span region R3. In some implementations, the third optical system 110 may be characterized by a transfer function response that includes the third frequency-span region R3 and has an FSR, where the third frequency-span region R3 is less than the FSR, and the third frequency response is a portion of the transfer function response.

In some implementations, the third optical system 110 may include two etalons having respective frequency responses phase-shifted by approximately one-quarter of an FSR from each other. As a result of the phase shift, a combination of the two etalons may have a unique frequency response across an FSR range, where the third frequency-span region R3 is the FSR in this example. Power measurements may be normalized, for example, by dividing etalon output power or photodetector current over a reference power or a reference photodetector current, respectively. The measurement circuit 114 may measure a first ratio (e.g., output value over reference value, such as output power/reference power) of a first etalon of the two etalons, and measure a second ratio of a second etalon of the two etalons. The first ratio and the second ratio may represent frequency-dependent measurements. The measurement circuit 114 may use both the first ratio and the second ratio in combination to determine a unique frequency measurement of the third measurement beam. For example, a combination of the first ratio and the second ratio may be calibrated to frequency, for example, by using a third calibration table. For example, the measurement circuit 114 may measure the first ratio and the second ratio, and cross-reference the first ratio and the second ratio to a frequency in the third calibration table to determine the third measured frequency F3. Additionally, or alternatively, one or more wavelength-dependent WDM couplers, monotonic filters, etalons, DLIs, and/or other interferometers may be used to uniquely define a third frequency response of the third frequency-span region R3, and may be used with associated measurement electronics to measure the third frequency of the third measurement beam to determine the third measured frequency F3. The third optical system 110 may be included in the optical frequency measurement system 100 to further refine an accuracy of the optical frequency measurement system 100. For example, the third measured frequency F3 may be a final measurement of the optical frequency measurement system 100, and may have a highest measurement accuracy. In some implementations, additional optical frequency measurement subsystems may be included to further increase an accuracy of the final measurement.

Each optical frequency measurement subsystem may generate, based on a corresponding measurement beam, one or more signals (e.g., currents, voltages, ADC codes, or ratios of other signals) which are used to assess the frequency of the light beam by comparing a combination of various output signals of the optical frequency measurement subsystem with a calibration table of signals versus frequency, by using a fitting model of the signals to frequency, or by associating a combination of signals or measurements to frequency in some other way, such as by a mapping.

The measurement circuit 114 may determine the second measured frequency F2 based on the first measured frequency F1 and the second frequency response, the second frequency response being located in the second frequency-span region R2. Additionally, the measurement circuit 114 may determine the third measured frequency F3 based on the second measured frequency F2 and the third frequency response, the third frequency response being located in the third frequency-span region R3.

For example, the second frequency-span region R2 may be defined by a first frequency boundary and a second frequency boundary, and the third frequency-span region R3 may be defined by a third frequency boundary and a fourth frequency boundary. The measurement circuit 114 may determine the second frequency-span region, including the first frequency boundary and the second frequency boundary, based on the first measured frequency F1. Moreover, the measurement circuit 114 may determine the third frequency-span region R3, including the third frequency boundary and a fourth frequency boundary, based on the second measured frequency F2. For example, the measurement circuit 114 may use the first measured frequency F1 as a center frequency of the second frequency-span region R2, and may use the second measured frequency F2 as a center frequency of the third frequency-span region R3. The first accuracy range +/−E1 may be sufficiently small to ensure that the first measured frequency F1 is within the second frequency-span region R2 in which the second frequency response is unique. The second accuracy range +/−E2 may be sufficiently small to ensure that the second measured frequency F2 is within the third frequency-span region R3 in which the third frequency response is unique.

Once the measurement circuit 114 has determined the second frequency-span region R2 from the first measured frequency F1, the measurement circuit 114 may measure the second frequency of the second measurement beam within the second frequency-span region R2 to determine the second measured frequency F2. Additionally, once the measurement circuit 114 has determined the third frequency-span region R3 from the second measured frequency F2, the measurement circuit 114 may measure the third frequency of the third measurement beam within the third frequency-span region R3 to determine the third measured frequency F3.

The measurement circuit 114 may be configured to sample and process measurement data from the first optical system 106, the second optical system 108, and the third optical system 110 in series or in parallel. However, parallel sampling may enable faster measurement acquisition rates. Thus, the first optical frequency measurement subsystem 116, the second optical frequency measurement subsystem 118, and the third optical frequency measurement subsystem 120 may sample the first measurement beam, the second measurement beam, and the third measurement beam in parallel, and provide respective sampling data to the measurement circuit 114 for determining the first measured frequency F1, the second measured frequency F2, and the third measured frequency F3.

The measurement circuit 114 may include a processing circuit including a memory configured to store at least one calibration table. The at least one calibration table may define the first frequency response based on first calibration values and corresponding first frequency values, the at least one calibration table may define the second frequency response based on second calibration values and corresponding second frequency values, and the at least one calibration table may define the third frequency response based on third calibration values and corresponding third frequency values. For example, the first calibration table, with the first calibration values cross-referenced to the corresponding first frequency values, may be provided for the first frequency response. The second calibration table, with the second calibration values cross-referenced to the corresponding second frequency values, may be provided for the second frequency response. The third calibration table, with the third calibration values cross-referenced to the corresponding third frequency values, may be provided for the third frequency response.

The processing circuit may receive at least one first measurement signal derived from the first optical system 106. For example, the processing circuit may receive the at least one first measurement signal from the plurality of ADCs 112. The processing circuit may determine the first measured frequency F1 from among the corresponding first frequency values based on the at least one first measurement signal and the first calibration values. For example, the processing circuit may determine one or more calibration values from the at least one first measurement signal, and may determine the first measured frequency F1 from the one or more calibration values based on the first calibration table.

The processing circuit may determine the second frequency-span region R2 based on the first measured frequency F1. The second frequency-span region R2 may define a range of corresponding second frequency values provided in the second calibration table. For example, the second frequency-span region R2 may limit the range of corresponding second frequency values to be evaluated by the processing circuit for determining the second measured frequency F2, which may decrease a processing time.

In some implementations, the processing circuit may receive at least two second measurement signals derived from the second optical system 108. For example, the processing circuit may receive the at least two second measurement signals from the plurality of ADCs 112. A first one of the second measurement signals may correspond to a first etalon, and a second one of the second measurement signals may correspond to a second etalon. Alternatively, the first one of the second measurement signals may correspond to a first channel of a DLI, and the second one of the second measurement signals may correspond to a second channel of the DLI. Alternatively, the first one of the second measurement signals may correspond to a first channel of a multi-slope etalon, and the second one of the second measurement signals may correspond to a second channel of the multi-slope etalon. Alternatively, the first one of the second measurement signals may correspond to one or more optical components that define a first frequency transfer function, and the second one of the second measurement signals may correspond to one or more optical components that define a second frequency transfer function.

The processing circuit may determine the second measured frequency F2 from among the corresponding second frequency values within the range of corresponding second frequency values based on the at least two second measurement signals and a subset of the second calibration values that correspond to the range of corresponding second frequency values. For example, the processing circuit may determine one or more calibration values from the at least two second measurement signals, and may determine the second measured frequency F2 from the one or more calibration values within the subset of the second calibration values based on the second calibration table.

In some implementations, the processing circuit may receive at least two third measurement signals derived from the third optical system 110. For example, the processing circuit may receive the at least two third measurement signals from the plurality of ADCs 112. The processing circuit may determine the third frequency-span region R3 based on the second measured frequency F2. The third frequency-span region R3 may define a range of corresponding third frequency values provided in the third calibration table. For example, the third frequency-span region R3 may limit the range of corresponding third frequency values to be evaluated by the processing circuit for determining the third measured frequency F3, which may decrease a processing time.

The processing circuit may determine the third measured frequency F3 from among the corresponding third frequency values within the range of corresponding third frequency values based on the at least two third measurement signals and a subset of the third calibration values that correspond to the range of corresponding third frequency values. For example, the processing circuit may determine one or more calibration values from the at least two third measurement signals, and may determine the third measured frequency F3 from the one or more calibration values within the subset of the third calibration values based on the third calibration table.

In some implementations, the processing circuit may generate interpolated calibration values based on interpolating the subset of the second calibration values, and may determine the second measured frequency F2 from among the corresponding second frequency values within the range of corresponding second frequency values based on the at least two second measurement signals and the interpolated calibration values. Similarly, the processing circuit may generate interpolated calibration values based on interpolating the subset of the third calibration values, and may determine the third measured frequency from among the corresponding third frequency values within the range of corresponding third frequency values based on the at least two third measurement signals and the interpolated calibration values.

In some implementations, the optical frequency measurement system 100 may include a polarization scrambler 122 arranged upstream from the beam splitter 104. The polarization scrambler 122 may be configured to randomize a polarization of the light beam. For example, the optical source 102 being measured may consist of any combination of polarizations which can also vary with time. The first optical system 106, the second optical system 108, and the third optical system 110 may each have a respective polarization dependency. For example, a response of a measurement may change depending on an input polarization of the light beam which, without any correction, may affect an accuracy of the optical frequency measurement system 100. The polarization scrambler 122 may randomize the polarization of the light beam before the light beam is split by the beam splitter 104. As a result, the polarization scrambler 122 may produce two orthogonal polarizations with equal amplitudes, for a specific time period. Thus, a final measurement of the optical frequency measurement system 100 may be an average of the two polarizations, which may eliminate errors that may occur based on polarization dependencies.

In some implementations, the first optical system 106, the second optical system 108, and the third optical system 110 may each have a respective temperature dependency. Thus, the optical frequency measurement system 100 may include a heater or thermoelectric device that maintains the first optical system 106, the second optical system 108, and the third optical system 110 at a fixed temperature.

As indicated above, FIG. 1 is provided as an example. Other examples may differ from what is described with regard to FIG. 1. The number and arrangement of devices and components shown in FIG. 1 are provided as an example. In practice, there may be additional devices or components, fewer devices or components, different devices or components, or differently arranged devices or components than those shown in FIG. 1.

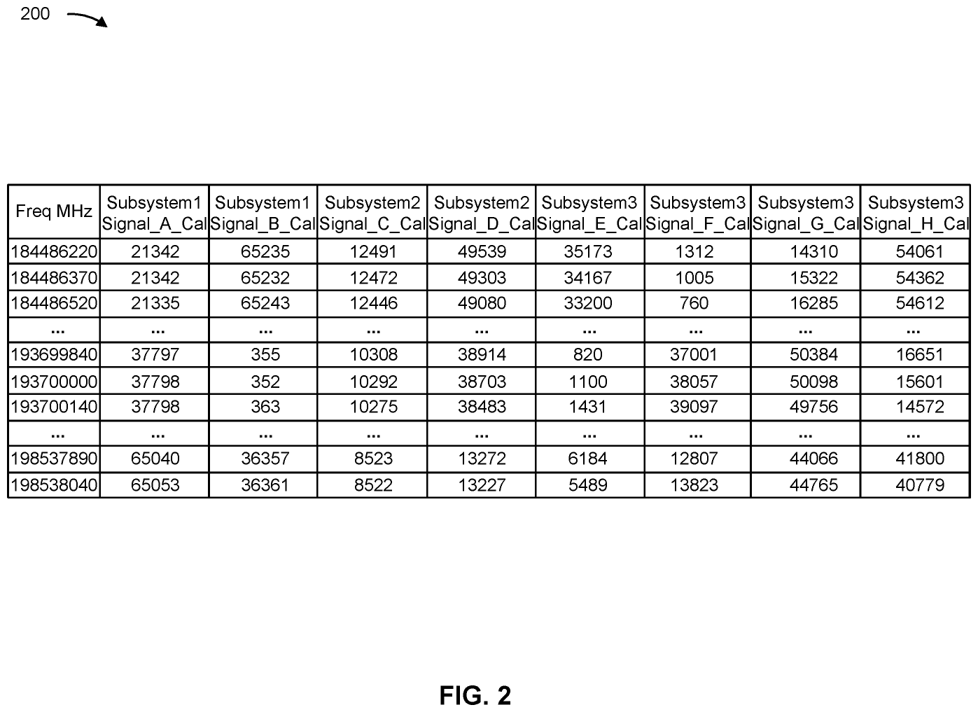

FIG. 2 illustrates an example calibration table 200 according to one or more implementations. In one example, the first optical system 106 may provide a signal_A and a signal_B within a unique frequency response range R1 of at least 14000 GHz covering C and L bands. Signal_A may be a power ratio of a C-band WDM coupler, and signal_B may be a power ratio of an L-band WDM coupler. The second optical system 108 may provide a signal_C and a signal_D with a unique frequency response range R2 of 200 GHz. Signal_C may be a power ratio of a first 200 GHz FSR etalon, and signal_D may be a power ratio of a second 200 GHz FSR wavelength locker, with a one-quarter phase shift relative to the first 200 GHz FSR etalon. The third optical system 110 may provide a signal_E, a signal_F, a signal_G, and a signal_H with a unique frequency response range R3 of 20 GHz. Signal_E, signal_F, signal_G, and signal_H may correspond to four channels from a differential quadrature phase shift keying (DQ-PSK) DLI with a 21.5 GHz FSR.

The measurement circuit 114 may sample signal_A, signal_B, signal_C, signal_D, signal_E, signal_F, signal_G, and signal_H in parallel to obtain eight measured signals signal_A_meas, signal_B_meas, signal_C_meas, signal_D_meas, signal_E_meas, signal_F_meas, signal_G_meas, and signal_H_meas. The measurement circuit 114 may search for a frequency entry in a calibration table which minimizes a mean squared error signal for signal_A and signal_B: mean squared error signal 1 to be minimized=½·((signal_A_meas−signal_A_cal)²+(signal_B_meas−signal_B_cal)²). Signal_A_cal and signal_B_cal may be calibration values corresponding to the C-band WDM coupler and the L-band WDM coupler, respectively. The mean squared error signal 1 may be the first measured frequency F1 with the first accuracy range +/−E1 in the first frequency-span region R1 (e.g., approximately the C+L bands). The first accuracy range +/−E1 may be quite wide (e.g., on the order of a few tens of GHz).

The measurement circuit 114 may search around the first measured frequency F1 with a search region smaller than F1+/−R2/2, where R2 is the second frequency-span region of the unique frequency response of the second optical frequency measurement subsystem 118. The measurement circuit 114 may search for a frequency entry in the calibration table which minimizes a mean squared error signal for signal_C and signal_D: mean squared error signal 2 to be minimized=½·((signal_C_meas−signal_C_cal)²+(signal_D_meas−signal_D_cal)²).

Signal_C_cal and signal_D_cal may be calibration values corresponding to the first 200 GHz FSR etalon and the second 200 GHz FSR etalon, respectively. The mean squared error signal 2 may be the second measured frequency F2 with the second accuracy range +/−E2 in the second frequency-span region R2 (e.g., approximately 200 GHz). The second accuracy range +/−E2 may be more narrow than the first accuracy range +/−E1 (e.g., +/−1 GHz).

In some implementations, the measurement circuit 114 may search for the second measured frequency F2 within F1+/−R2/2*0.8, or 80% of a range of second frequency-span region R2, in order to reduce a risk of not ending up in the unique frequency response region of the second frequency response due to errors from the first accuracy range +/−E1 and the second accuracy range +/−E2.

The measurement circuit 114 may search around the second measured frequency F2 with a search region smaller than F2+/−R3/2, where R3 is the third frequency-span region of the unique frequency response of the third optical frequency measurement subsystem 120. The measurement circuit 114 may search for a frequency entry in the calibration table which minimizes a mean squared error signal for signal_E, signal_F, signal_G, and signal_H: mean squared error signal 3 to be minimized=¼·((signal_E_meas−signal_E_cal)²+(signal_F_meas−signal_F_cal)²+(signal_G_meas−signal_G_cal)²+ (signal_H_meas−signal_H_cal)²). Signal_E_cal, signal_F_cal, signal_G_cal, and signal_H_cal may be calibration values corresponding to respective channels of the DQ-PSK DLI. The mean squared error signal 3 may be the third measured frequency F3 with the third accuracy range +/−E3 in the third frequency-span region R3 (e.g., approximately 20 GHz). The third accuracy range +/−E3 may be more narrow than the second accuracy range +/−E2 (e.g., +/−0.1 GHZ).

In some implementations, the measurement circuit 114 may search for the third measured frequency F3 within F2+/−R3/2*0.8, or 80% of a range of third frequency-span region R3 in order to reduce a risk of not ending up in the unique frequency response region of the third frequency response due to errors from the first accuracy range +/−E1, the second accuracy range +/−E2, and the third accuracy range +/−E3.

If the resolution of the calibration table is not enough because the calibration steps in the calibration table are too wide, the measurement circuit 114 may perform interpolation of the calibration table around third measured frequency F3 (+/−0.5 calibration table steps) and refine the third measured frequency F3 to be F3′. The interpolation may be done by, for example, linearly interpolating the calibration table from F3−0.5*TableCalStep to F3+0.5+TableCalStep and generating ten new entries around the calibration entry for the third measured frequency F3. TableCalStep may be one of the calibration values in the calibration table. Using the new ten new entries, the measurement circuit 114 may determine the entry (frequency F3′) in the calibration table that minimizes the mean squared error signal 3, according to mean squared error signal 3′ to be minimized=¼·((Signal_E_Meas−Signal_E_Cal(n))²+(Signal_F_Meas−Signal_F_Cal(n))²+ (Signal_G_Meas−Signal_G_Cal(n))²+(Signal_H_Meas−Signal_H_Cal(n))²), with n=0 to 9.

As indicated above, FIG. 2 is provided as an example. Other examples may differ from what is described with regard to FIG. 2.

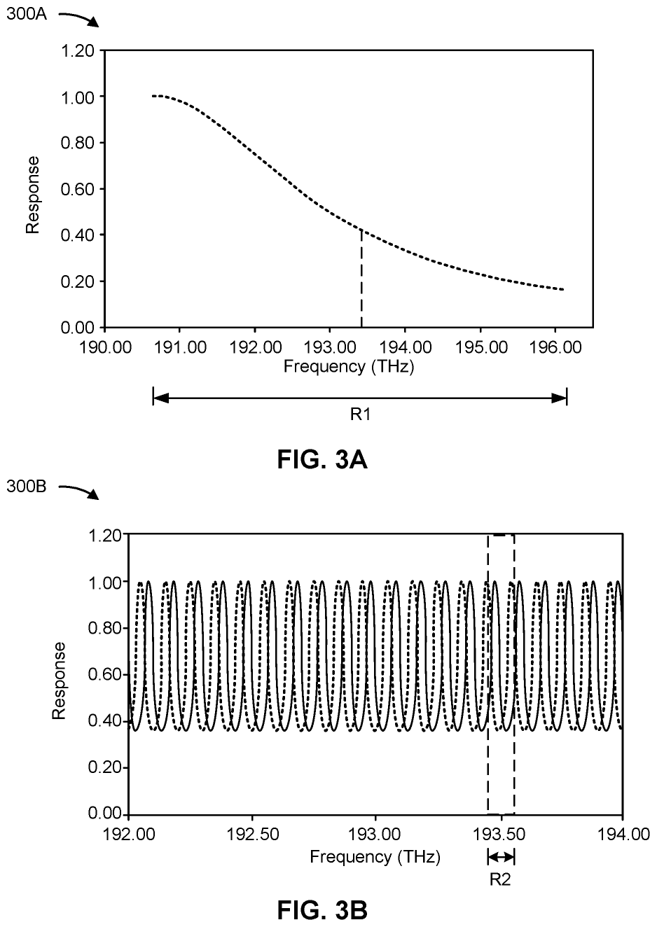

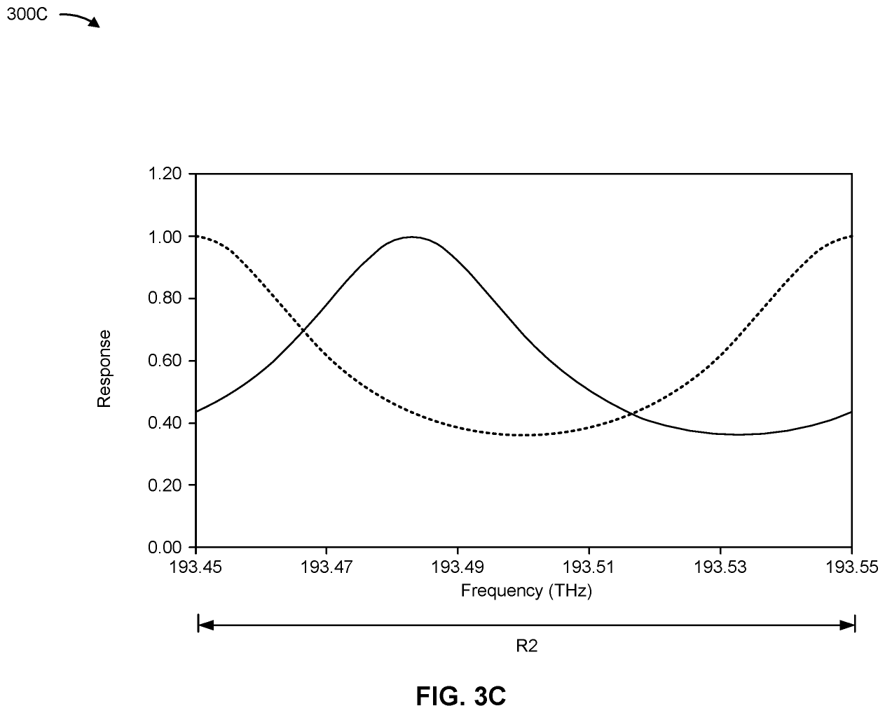

FIG. 3A shows a plot 300A of a unique frequency response of the first optical system 106 of the optical frequency measurement system 100. Using the first optical system 106, the optical frequency measurement system 100 may estimate an optical frequency of about 193.50 THz within the first frequency-span region R1 corresponding to a frequency range or wavelength range of interest. The first optical frequency measurement subsystem 116 may provide an initial measurement of the frequency of the light beam, which is then used by the measurement circuit 114 to determine the second frequency-span region R2. In other words, the initial measurement may be used to identify a range to be searched for determining the second measurement frequency F2.

As indicated above, FIG. 3A is provided as an example. Other examples may differ from what is described with regard to FIG. 3A.

FIGS. 3B and 3C show plots 300B and 300C of a frequency response of the second optical system 108 of the optical frequency measurement system 100, respectively. The measurement circuit 114 may determine the second frequency-span region R2 based on the first measured frequency F1. For example, the second frequency-span region R2 may be centered on the first measured frequency F1. Thus, the second frequency-span region R2 defines a region to be searched (e.g., a range of entries to be searched in a calibration table) for determining the second measured frequency F2.

As indicated above, FIGS. 3B and 3C are provided as examples. Other examples may differ from what is described with regard to FIGS. 3B and 3C.

The following provides an overview of some Aspects of the present disclosure:

Aspect 1: An optical frequency measurement system, comprising: a beam splitter configured to split a light beam into a plurality of measurement beams, including a first measurement beam and a second measurement beam; a first optical frequency measurement subsystem configured to receive the first measurement beam and measure a first frequency of the first measurement beam with a first accuracy range to obtain a first measured frequency that corresponds to a frequency of the light beam; and a second optical frequency measurement subsystem configured to receive the second measurement beam and measure a second frequency of the second measurement beam with a second accuracy range that is narrower than the first accuracy range to obtain a second measured frequency that corresponds to the frequency of the light beam with a higher accuracy than the first measured frequency, wherein the first optical frequency measurement subsystem comprises a first optical system having a first frequency response that is unique across a first frequency-span region such that each different frequency value within the first frequency-span region corresponds to a unique measurement value of the first measured frequency, the first frequency being within the first frequency-span region, wherein the second optical frequency measurement subsystem comprises a second optical system having a second frequency response that is unique across a second frequency-span region such that each different frequency value within the second frequency-span region corresponds to a unique measurement value of the second measured frequency, the second frequency being within the second frequency-span region, wherein the second frequency-span region is narrower than the first frequency-span region, wherein the second frequency-span region is centered on the first measured frequency, and wherein the first accuracy range is narrower than half of a frequency range of the second frequency-span region.

Aspect 2: The optical frequency measurement system of Aspect 1, wherein the second frequency response is unique when the second frequency-span region is centered on any frequency within the first frequency-span region.

Aspect 3: The optical frequency measurement system of any of Aspects 1-2, further comprising: a measurement circuit configured to determine the second measured frequency based on the first measured frequency and the second frequency response, the second frequency response being located in the second frequency-span region.

Aspect 4: The optical frequency measurement system of any of Aspects 1-3, wherein the first optical frequency measurement subsystem has a first measurement resolution, and the second optical frequency measurement subsystem has a second measurement resolution that is higher than the first measurement resolution.

Aspect 5: The optical frequency measurement system of Aspect 3, wherein the first optical frequency measurement subsystem and the second optical frequency measurement subsystem are configured to sample the first measurement beam and the second measurement beam in parallel, respectively, and provide respective sampling data to the measurement circuit for determining the first measured frequency and the second measured frequency.

Aspect 6: The optical frequency measurement system of any of Aspects 1-5, wherein the second frequency-span region is defined by a first frequency boundary and a second frequency boundary, and wherein the optical frequency measurement system further comprises: a measurement circuit configured to determine the second frequency-span region based on the first measured frequency.

Aspect 7: The optical frequency measurement system of Aspect 6, wherein the measurement circuit is configured to measure the second frequency within the second frequency-span region, wherein the measurement circuit is configured to use the first measured frequency as a center frequency of the second frequency-span region.

Aspect 8: The optical frequency measurement system of Aspect 6, wherein the first accuracy range is sufficiently small to ensure that the first measured frequency is within the second frequency-span region in which the second frequency response is unique.

Aspect 9: The optical frequency measurement system of any of Aspects 1-8, wherein the second frequency-span region is at least two times smaller than the first frequency-span region.

Aspect 10: The optical frequency measurement system of any of Aspects 1-9, wherein the second accuracy range is at least one order of magnitude smaller than the second frequency-span region, or the second accuracy range is at least one order of magnitude smaller than the first accuracy range.

Aspect 11: The optical frequency measurement system of any of Aspects 1-10, wherein the first optical system comprises at least one first optical filter that defines the first accuracy range and defines the first frequency response that is unique across the first frequency-span region, and wherein the second optical system comprises at least one second optical filter that defines the second accuracy range and defines the second frequency response that is unique across the second frequency-span region.

Aspect 12: The optical frequency measurement system of Aspect 11, wherein the at least one first optical filter includes at least one monotonic filter, at least one wavelength-division multiplexing coupler, or at least one periodic filter, and wherein the at least one second optical filter includes at least two periodic filters.

Aspect 13: The optical frequency measurement system of any of Aspects 1-12, wherein the first optical system includes a first plurality of optical components that, in combination, provide the first frequency response that is unique across the first frequency-span region, and wherein the second optical system includes a second plurality of optical components that, in combination, provide the second frequency response that is unique across the second frequency-span region.

Aspect 14: The optical frequency measurement system of Aspect 11, wherein the second optical system is characterized by a transfer function response that includes the second frequency-span region and has a free spectral range (FSR), wherein the second frequency-span region is less than the FSR, and wherein the second frequency response is a portion of the transfer function response.

Aspect 15: The optical frequency measurement system of any of Aspects 1-14, wherein the plurality of measurement beams includes a third measurement beam, wherein the optical frequency measurement system further comprises: a third optical frequency measurement subsystem configured to receive the third measurement beam and measure a third frequency of the third measurement beam with a third accuracy range that is narrower than the second accuracy range to obtain a third measured frequency that corresponds to the frequency of the light beam with a higher accuracy than the second measured frequency, wherein the third optical frequency measurement subsystem comprises a third optical system having a third frequency response that is unique across a third frequency-span region such that each different frequency value within the third frequency-span region corresponds to a unique measurement value of the third measured frequency, the third frequency being within the third frequency-span region, wherein the third frequency-span region is narrower than the second frequency-span region, wherein the third frequency-span region is centered on the second measured frequency, and wherein the second accuracy range is narrower than half of a frequency range of the third frequency-span region.

Aspect 16: The optical frequency measurement system of Aspect 15, further comprising: a measurement circuit configured to determine the second measured frequency based on the first measured frequency and the second frequency response, the second frequency response being located in the second frequency-span region, and wherein the measurement circuit is configured to determine the third measured frequency based on the second measured frequency and the third frequency response, the third frequency response being located in the third frequency-span region.

Aspect 17: The optical frequency measurement system of Aspect 15, wherein the second frequency-span region is defined by a first frequency boundary and a second frequency boundary, wherein the third frequency-span region is defined by a third frequency boundary and a fourth frequency boundary, and wherein the optical frequency measurement system further comprises: a measurement circuit configured to determine the second frequency-span region based on the first measured frequency, and determine the third frequency-span region based on the second measured frequency.

Aspect 18: The optical frequency measurement system of Aspect 17, wherein the measurement circuit is configured to measure the second frequency within the second frequency-span region, wherein the measurement circuit is configured to use the first measured frequency as a center frequency of the second frequency-span region, and wherein the measurement circuit is configured to measure the third frequency within the third frequency-span region, wherein the measurement circuit is configured to use the second measured frequency as a center frequency of the third frequency-span region.

Aspect 19: The optical frequency measurement system of any of Aspects 1-18, further comprising: a processing circuit including a memory configured to store at least one calibration table, wherein the at least one calibration table defines the first frequency response based on first calibration values and corresponding first frequency values, and wherein the at least one calibration table defines the second frequency response based on second calibration values and corresponding second frequency values, wherein the processing circuit is configured to receive at least one first measurement signal derived from the first optical system, wherein the processing circuit is configured to receive at least two second measurement signals derived from the second optical system, wherein the processing circuit is configured to determine the first measured frequency from among the corresponding first frequency values based on the at least one first measurement signal and the first calibration values, wherein the processing circuit is configured to determine the second frequency-span region based on the first measured frequency, wherein the second frequency-span region defines a range of corresponding second frequency values provided in the at least one calibration table, and wherein the processing circuit is configured to determine the second measured frequency from among the corresponding second frequency values within the range of corresponding second frequency values based on the at least two second measurement signals and a subset of the second calibration values that correspond to the range of corresponding second frequency values.

Aspect 20: The optical frequency measurement system of Aspect 19, wherein the processing circuit is configured to generate interpolated calibration values based on interpolating the subset of the second calibration values, and determine the second measured frequency from among the corresponding second frequency values within the range of corresponding second frequency values based on the at least two second measurement signals and the interpolated calibration values.

Aspect 21: The optical frequency measurement system of any of Aspects 1-20, further comprising: a polarization scrambler arranged upstream from the beam splitter, wherein the polarization scrambler is configured to randomize a polarization of the light beam.

Aspect 22: The optical frequency measurement system of any of Aspects 1-21, wherein

a sum of the first accuracy range and the second accuracy range is less than half of the frequency range of the second frequency-span region.

Aspect 23: A method, comprising: splitting, by a beam splitter, a light beam into a plurality of measurement beams, including a first measurement beam and a second measurement beam; measuring, by a first optical frequency measurement subsystem, a first frequency of the first measurement beam with a first accuracy range to obtain a first measured frequency that corresponds to a frequency of the light beam; and measuring, by a second optical frequency measurement subsystem, a second frequency of the second measurement beam with a second accuracy range to obtain a second measured frequency that corresponds to the frequency of the light beam with a higher accuracy than the first measured frequency, wherein the first optical frequency measurement subsystem comprises a first optical system having a first frequency response that is unique across a first frequency-span region such that the first measured frequency is unique to the first frequency provided at an input of the first optical system a first frequency response that is unique across a first frequency-span region such that each different frequency value within the first frequency-span region corresponds to a unique measurement value of the first measured frequency, the first frequency being within the first frequency-span region, wherein the second optical frequency measurement subsystem comprises a second optical system having a second frequency response that is unique across a second frequency-span region such that the second measured frequency is unique to the second frequency provided at an input of the second optical system a second frequency response that is unique across a second frequency-span region such that each different frequency value within the second frequency-span region corresponds to a unique measurement value of the second measured frequency, the second frequency being within the second frequency-span region, wherein the second frequency-span region is narrower than the first frequency-span region, wherein the second frequency-span region is centered on the first measured frequency, and wherein the first accuracy range is narrower than half of a frequency range of the second frequency-span region.

Aspect 24: The method of Aspect 23, wherein at least one calibration table defines the first frequency response based on first calibration values and corresponding first frequency values, and wherein the at least one calibration table defines the second frequency response based on second calibration values and corresponding second frequency values, wherein the method further comprises: determining the first measured frequency from among the corresponding first frequency values based on at least one first measurement signal and the first calibration values, the at least one first measurement signal being derived from the first optical system; determining the second frequency-span region based on the first measured frequency, wherein the second frequency-span region defines a range of corresponding second frequency values provided in the at least one calibration table; and determining the second measured frequency from among the corresponding second frequency values within the range of corresponding second frequency values based on at least two second measurement signals and a subset of the second calibration values that correspond to the range of corresponding second frequency values, the at least two second measurement signals being derived from the first optical system.

Aspect 25: A system configured to perform one or more operations recited in one or more of Aspects 1-24.

Aspect 26: An apparatus comprising means for performing one or more operations recited in one or more of Aspects 1-24.

Aspect 27: A non-transitory computer-readable medium storing a set of instructions, the set of instructions comprising one or more instructions that, when executed by a device, cause the device to perform one or more operations recited in one or more of Aspects 1-24.

Aspect 28: A computer program product comprising instructions or code for executing one or more operations recited in one or more of Aspects 1-24.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical frequency measurement system, comprising:
a beam splitter configured to split a light beam into a plurality of measurement beams, including a first measurement beam and a second measurement beam;
a first optical frequency measurement subsystem configured to receive the first measurement beam and measure a first frequency of the first measurement beam with a first accuracy range to obtain a first measured frequency that corresponds to a frequency of the light beam; and
a second optical frequency measurement subsystem configured to receive the second measurement beam and measure a second frequency of the second measurement beam with a second accuracy range that is narrower than the first accuracy range to obtain a second measured frequency that corresponds to the frequency of the light beam with a higher accuracy than the first measured frequency,
wherein the first optical frequency measurement subsystem comprises a first optical system having a first frequency response that is unique across a first frequency-span region such that each different frequency value within the first frequency-span region corresponds to a unique measurement value of the first measured frequency, the first frequency being within the first frequency-span region,
wherein the second optical frequency measurement subsystem comprises a second optical system having a second frequency response that is unique across a second frequency-span region such that each different frequency value within the second frequency-span region corresponds to a unique measurement value of the second measured frequency, the second frequency being within the second frequency-span region,
wherein the second frequency-span region is narrower than the first frequency-span region,
wherein the second frequency-span region is centered on the first measured frequency, and
wherein the first accuracy range is narrower than half of a frequency range of the second frequency-span region.

2. The optical frequency measurement system of claim 1, wherein the second frequency response is unique when the second frequency-span region is centered on any frequency within the first frequency-span region.

3. The optical frequency measurement system of claim 1, further comprising:
a measurement circuit configured to determine the second measured frequency based on the first measured frequency and the second frequency response, the second frequency response being located in the second frequency-span region.

4. The optical frequency measurement system of claim 1, wherein the first optical frequency measurement subsystem has a first measurement resolution, and the second optical frequency measurement subsystem has a second measurement resolution that is higher than the first measurement resolution.

5. The optical frequency measurement system of claim 3, wherein the first optical frequency measurement subsystem and the second optical frequency measurement subsystem are configured to sample the first measurement beam and the second measurement beam in parallel, respectively, and provide respective sampling data to the measurement circuit for determining the first measured frequency and the second measured frequency.

6. The optical frequency measurement system of claim 1, wherein the second frequency-span region is defined by a first frequency boundary and a second frequency boundary, and
wherein the optical frequency measurement system further comprises:
a measurement circuit configured to determine the second frequency-span region based on the first measured frequency.

7. The optical frequency measurement system of claim 6, wherein the measurement circuit is configured to measure the second frequency within the second frequency-span region, wherein the measurement circuit is configured to use the first measured frequency as a center frequency of the second frequency-span region.

8. The optical frequency measurement system of claim 6, wherein the first accuracy range is sufficiently small to ensure that the first measured frequency is within the second frequency-span region in which the second frequency response is unique.

9. The optical frequency measurement system of claim 1, wherein the second frequency-span region is at least two times smaller than the first frequency-span region.

10. The optical frequency measurement system of claim 1, wherein the second accuracy range is at least one order of magnitude smaller than the second frequency-span region, or the second accuracy range is at least one order of magnitude smaller than the first accuracy range.

11. The optical frequency measurement system of claim 1, wherein the first optical system comprises at least one first optical filter that defines the first accuracy range and defines the first frequency response that is unique across the first frequency-span region, and
wherein the second optical system comprises at least one second optical filter that defines the second accuracy range and defines the second frequency response that is unique across the second frequency-span region.

12. The optical frequency measurement system of claim 11, wherein the at least one first optical filter includes at least one monotonic filter, at least one wavelength-division multiplexing coupler, or at least one periodic filter, and
wherein the at least one second optical filter includes at least two periodic filters.

13. The optical frequency measurement system of claim 1, wherein the first optical system includes a first plurality of optical components that, in combination, provide the first frequency response that is unique across the first frequency-span region, and
wherein the second optical system includes a second plurality of optical components that, in combination, provide the second frequency response that is unique across the second frequency-span region.

14. The optical frequency measurement system of claim 11, wherein the second optical system is characterized by a transfer function response that includes the second frequency-span region and has a free spectral range (FSR),
wherein the second frequency-span region is less than the FSR, and
wherein the second frequency response is a portion of the transfer function response.

15. The optical frequency measurement system of claim 1, wherein the plurality of measurement beams includes a third measurement beam,
wherein the optical frequency measurement system further comprises:
a third optical frequency measurement subsystem configured to receive the third measurement beam and measure a third frequency of the third measurement beam with a third accuracy range that is narrower than the second accuracy range to obtain a third measured frequency that corresponds to the frequency of the light beam with a higher accuracy than the second measured frequency,
wherein the third optical frequency measurement subsystem comprises a third optical system having a third frequency response that is unique across a third frequency-span region such that each different frequency value within the third frequency-span region corresponds to a unique measurement value of the third measured frequency, the third frequency being within the third frequency-span region,
wherein the third frequency-span region is narrower than the second frequency-span region,
wherein the third frequency-span region is centered on the second measured frequency, and
wherein the second accuracy range is narrower than half of a frequency range of the third frequency-span region.

16. The optical frequency measurement system of claim 15, further comprising:
a measurement circuit configured to determine the second measured frequency based on the first measured frequency and the second frequency response, the second frequency response being located in the second frequency-span region, and
wherein the measurement circuit is configured to determine the third measured frequency based on the second measured frequency and the third frequency response, the third frequency response being located in the third frequency-span region.

17. The optical frequency measurement system of claim 15, wherein the second frequency-span region is defined by a first frequency boundary and a second frequency boundary,
wherein the third frequency-span region is defined by a third frequency boundary and a fourth frequency boundary, and
wherein the optical frequency measurement system further comprises:
a measurement circuit configured to determine the second frequency-span region based on the first measured frequency, and determine the third frequency-span region based on the second measured frequency.

18. The optical frequency measurement system of claim 17, wherein the measurement circuit is configured to measure the second frequency within the second frequency-span region, wherein the measurement circuit is configured to use the first measured frequency as a center frequency of the second frequency-span region, and
wherein the measurement circuit is configured to measure the third frequency within the third frequency-span region, wherein the measurement circuit is configured to use the second measured frequency as a center frequency of the third frequency-span region.

19. The optical frequency measurement system of claim 1, further comprising:
a processing circuit including a memory configured to store at least one calibration table, wherein the at least one calibration table defines the first frequency response based on first calibration values and corresponding first frequency values, and wherein the at least one calibration table defines the second frequency response based on second calibration values and corresponding second frequency values,
wherein the processing circuit is configured to receive at least one first measurement signal derived from the first optical system,
wherein the processing circuit is configured to receive at least two second measurement signals derived from the second optical system,
wherein the processing circuit is configured to determine the first measured frequency from among the corresponding first frequency values based on the at least one first measurement signal and the first calibration values,
wherein the processing circuit is configured to determine the second frequency-span region based on the first measured frequency, wherein the second frequency-span region defines a range of corresponding second frequency values provided in the at least one calibration table, and
wherein the processing circuit is configured to determine the second measured frequency from among the corresponding second frequency values within the range of corresponding second frequency values based on the at least two second measurement signals and a subset of the second calibration values that correspond to the range of corresponding second frequency values.

20. The optical frequency measurement system of claim 19, wherein the processing circuit is configured to generate interpolated calibration values based on interpolating the subset of the second calibration values, and determine the second measured frequency from among the corresponding second frequency values within the range of corresponding second frequency values based on the at least two second measurement signals and the interpolated calibration values.

21. The optical frequency measurement system of claim 1, further comprising:
a polarization scrambler arranged upstream from the beam splitter, wherein the polarization scrambler is configured to randomize a polarization of the light beam.

22. The optical frequency measurement system of claim 1, wherein a sum of the first accuracy range and the second accuracy range is less than half of the frequency range of the second frequency-span region.

23. A method, comprising:
splitting, by a beam splitter, a light beam into a plurality of measurement beams, including a first measurement beam and a second measurement beam;
measuring, by a first optical frequency measurement subsystem, a first frequency of the first measurement beam with a first accuracy range to obtain a first measured frequency that corresponds to a frequency of the light beam; and
measuring, by a second optical frequency measurement subsystem, a second frequency of the second measurement beam with a second accuracy range to obtain a second measured frequency that corresponds to the frequency of the light beam with a higher accuracy than the first measured frequency,
wherein the first optical frequency measurement subsystem comprises a first optical system having a first frequency response that is unique across a first frequency-span region such that the first measured frequency is unique to the first frequency provided at an input of the first optical system a first frequency response that is unique across a first frequency-span region such that each different frequency value within the first frequency-span region corresponds to a unique measurement value of the first measured frequency, the first frequency being within the first frequency-span region,
wherein the second optical frequency measurement subsystem comprises a second optical system having a second frequency response that is unique across a second frequency-span region such that the second measured frequency is unique to the second frequency provided at an input of the second optical system a second frequency response that is unique across a second frequency-span region such that each different frequency value within the second frequency-span region corresponds to a unique measurement value of the second measured frequency, the second frequency being within the second frequency-span region,
wherein the second frequency-span region is narrower than the first frequency-span region,
wherein the second frequency-span region is centered on the first measured frequency, and
wherein the first accuracy range is narrower than half of a frequency range of the second frequency-span region.

24. The method of claim 23, wherein at least one calibration table defines the first frequency response based on first calibration values and corresponding first frequency values, and wherein the at least one calibration table defines the second frequency response based on second calibration values and corresponding second frequency values,
wherein the method further comprises:
determining the first measured frequency from among the corresponding first frequency values based on at least one first measurement signal and the first calibration values, the at least one first measurement signal being derived from the first optical system;
determining the second frequency-span region based on the first measured frequency, wherein the second frequency-span region defines a range of corresponding second frequency values provided in the at least one calibration table; and
determining the second measured frequency from among the corresponding second frequency values within the range of corresponding second frequency values based on at least two second measurement signals and a subset of the second calibration values that correspond to the range of corresponding second frequency values, the at least two second measurement signals being derived from the first optical system.
